(19) United States
(12) Patent Application Publication
(10) Pub. No.: US 2008/0012361 A1
(43) Pub. Date: Jan. 17, 2008

(54) KEY-OPERATED HANDLE KNOB ASSEMBLY HAVING HIGH COMPRESSIVE STRENGTH

(76) Inventors: Chia-Min SUN, Chia-Yi City (TW); Ju-Lin YANG, Chia-Yi County (TW); Song-Gen SHYU, Chia-Yi Hsien (TW)

Correspondence Address: LADAS & PARRY LLP, 224 SOUTH MICHIGAN AVENUE, SUITE 1600, CHICAGO, IL, 60604, US

(21) Appl. No.: 11/740,341

(22) Filed: Apr. 26, 2007

(30) Foreign Application Priority Data
Apr. 28, 2006 (TW) 095207477

(51) Int. Cl. E05B 1/00

(52) U.S. Cl. 292/347

(57) ABSTRACT

A handle knob assembly comprises a knob shell and a lock retainer disposed within the knob shell. The lock retainer includes a hollow drum portion, a hollow neck part extending rearwardly from the drum portion and projecting out of a rear opening of the knob shell, a lock-receiving hole formed in the drum portion and aligned with a key hole of the knob shell, a plurality of annularly spaced apart and axially extending ribs that project radially from an outer periphery of the drum portion, and a ring extending around the ribs and having a distal peripheral end extending toward an inner surface of the knob shell. The construction as such saves the cost of materials and provides sufficient strength to resist radial compressive forces.

### CROSS-REFERENCE TO RELATED APPLICATION

This application claims priority of Taiwanese Application No. 095207477, filed on Apr. 28, 2006.

### BACKGROUND OF THE INVENTION

1. Field of the Invention

The invention relates to a key-operated handle knob, more particularly to a high compressive strength handle knob incorporating a cylinder lock therein.

2. Description of the Related Art

In manufacturing door handles, key-operated door handles are classified into many grades according to the structural strengths thereof. There are different testing standards to determine the grades of the door handles. Early handle knobs mountable on door panels either at the outside or inside thereof are generally provided with a solid structure in order to meet a desired grade of strength. However, the solid handle knobs are incompetitive in terms of prices due to the increasingly high cost of materials for making handle knobs.

In order to reduce costs, various forms of handle knobs having hollow structures have been developed. U.S. Patent Publication No. 2006/0081024 A1 discloses a door handle assembly that includes a hollow knob shell, and a lock cylinder. A sleeve is disposed within the knob shell to support the lock cylinder. However, such a door handle assembly does not have sufficient strength to resist compressive forces that are exerted in radial directions. U.S. Pat. No. 6,360,570 discloses a knob assembly, which comprises outer and inner knob housings both having front ends formed with 8-shaped front holes. A lock cylinder is disposed within the inner knob housing and supported by a spindle and a sleeve which are inserted into the inner knob housing. Compressive strength is improved due to the use of the outer and inner knob housings.

### SUMMARY OF THE INVENTION

The main object of the present invention is to provide a handle knob assembly with a novel construction that provides high strength to resist radial compressive forces.

According to this invention, a handle knob assembly comprises: a knob shell having a front end provided with a key hole, and a rear end having a rear opening; and a lock retainer disposed within the knob shell and including a hollow drum portion, a hollow neck part extending rearwardly from the drum portion and projecting out of the rear opening, a lock-receiving hole formed in the drum portion and aligned with the key hole, a plurality of annularly spaced apart ribs that project radially from an outer periphery of the drum portion and that extend substantially in an axial direction, and a ring extending around the ribs and having a distal peripheral end extending substantially radially toward an inner surface of the knob shell.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded view of a preferred embodiment of the handle knob assembly according to the present invention, the exploded view being viewed in one direction;

FIG. 2 is another exploded view of the preferred embodiment that is viewed in another opposite direction;

FIG. 3 is a perspective view of the preferred embodiment in an assembled state;

FIG. 4 is the same view as FIG. 3 but showing additionally a cylinder lock which has not been assembled in a lock retainer;

FIG. 5 is the same view as FIG. 3 but showing that the cylinder lock is assembled in the lock retainer;

FIG. 6 is a sectional view taken along line 6-6 of FIG. 3;

FIG. 7 is a perspective view showing that an annular plate is provided at the rear end of a drum portion of the lock retainer; and

FIG. 8 is an exploded view showing that the lock retainer and the annular plate of FIG. 7.

### DETAILED DESCRIPTION OF THE PREFERRED EMBODIMENTS

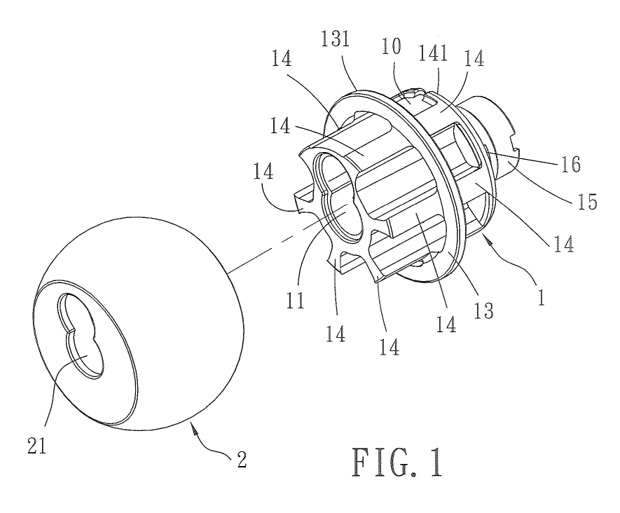

Referring to FIGS. 1-5, a preferred embodiment of a handle knob assembly according to the present invention includes a lock retainer 1 and a knob shell 2. The knob shell 2 has a front end provided with an 8-shaped key hole 21, and a rear end provided with a rear opening 22.

The lock retainer 1 is disposed within the knob shell 2 and may be made from a zinc alloy or a copper alloy. The lock retainer 1 includes a hollow drum portion 10, a hollow neck part 15 extending rearwardly from the drum portion 10 and projecting out of the rear opening 22 of the knob shell 2, and a lock-receiving hole 11 formed in the drum portion 10 and aligned with the key hole 21. A plurality of annularly spaced apart and axially extending ribs 14 project from an outer periphery of the drum portion 10. A ring 13 extends around the ribs 14 and has a distal peripheral end 131 extending toward an inner surface of the knob shell 2.

Preferably, the distal peripheral end 131 is placed in abutment with the inner surface of the knob shell 2 between front and rear ends of the knob shell 2. The front and rear ends of the ribs 14 extend to the front and rear ends of the drum portion 10 and abut against the inner surface of the knob shell 2 at the front and rear ends of the knob shell 2. Furthermore, a rear rim 141 is provided at the rear end of the drum portion 10 to interconnect the rear ends of the ribs 14 and to abut against the inner surface of the knob shell 2 at the rear end of the knob shell 2. However, the rear rim 141 is optional and may be omitted according to the present invention. Alternatively, a front rim similar to the rear rim 141 may be provided at the front end of the drum portion 10 to interconnect the front ends of the ribs 14 and to abut against the inner surface of the knob shell 2 at the front end of the knob shell 2.

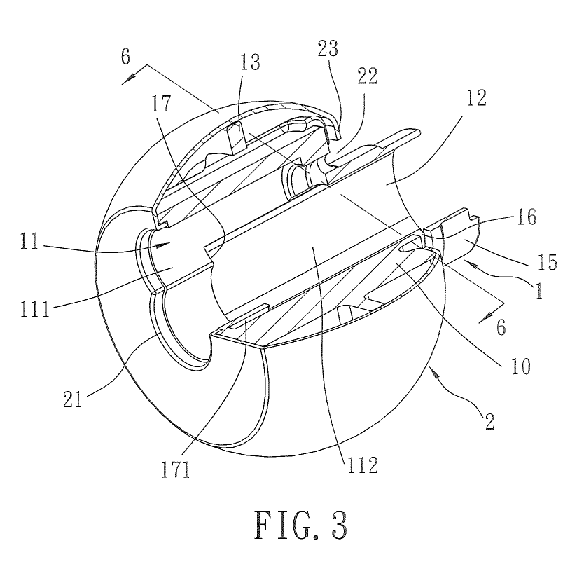

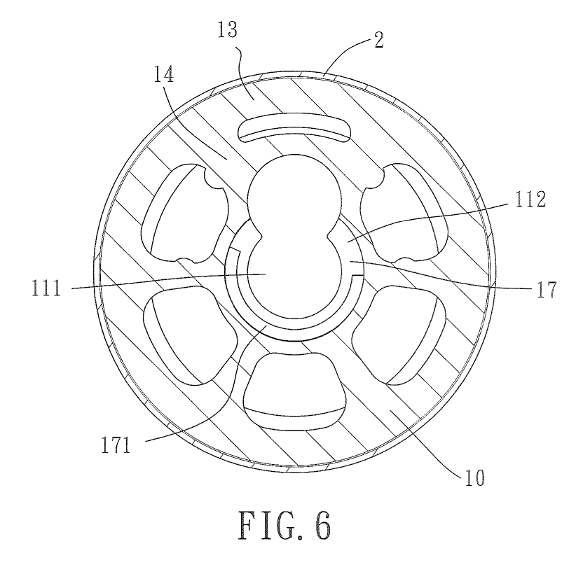

The hollow neck part 15 of the lock retainer 1 confines a substantially circular hole 12 and is provided for insertion of a tubular drive spindle (not shown) used to operate a latch (not shown). The hollow neck part 15 is provided with an engaging part 16 to engage the tubular drive spindle. Referring to FIG. 6 in combination with FIG. 3, the lock-receiving hole 11 has a front hole section 111 of 8-shaped cross section corresponding to the 8-shaped key hole 21, and a rear hole section 112 communicated with the front hole section 111 and the circular hole 12. The rear hole section 112 has a portion that is aligned with and corresponds in cross section to the circular hole 12 and that is wider than the 8-shaped front hole section 111. A shoulder face 17 is thus formed between the aforesaid portion of the rear hole section 112 and the front hole sections 111. A substantially C-shaped groove 171 is formed in the shoulder face 17 and extends forwardly from the shoulder face 17. When the handle knob assembly is mounted on a door panel, the tubular drive spindle (not shown) that operates the latch (not shown) will be inserted into the hollow neck part 15, and an engaging end (not shown) of the tubular drive spindle can be inserted into the C-shaped groove 171.

The handle knob assembly of the present invention further includes a cylinder lock 3 disposed within the front and rear hole sections 111 and 112 of the lock-receiving hole 11. The cylinder lock 3 is conventional and has an outer case 30 of substantially 8-shaped cross section and a core 32 mounted in the outer case 30. A retractable wing 31 projects outwardly from the outer case 30.

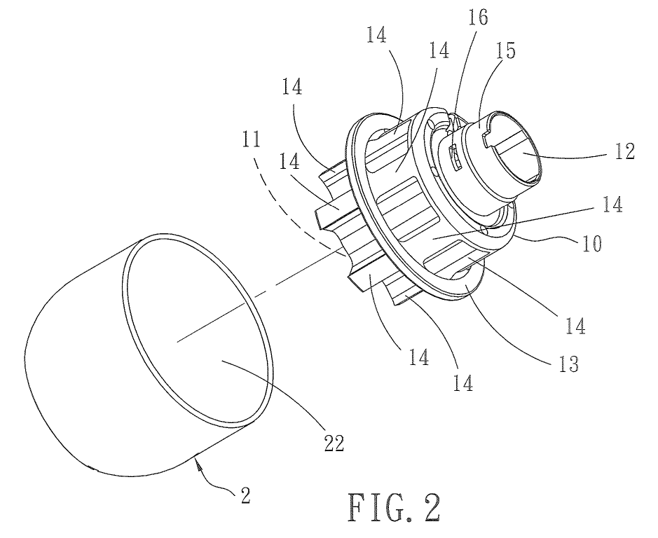

Referring back to FIG. 2, the rear end of the knob shell 2 is not bent inward before the lock retainer 1 is placed within the knob shell 2 so that the size of the rear opening 22 is larger than that of the ring 13 and the lock retainer 1 can be inserted in the knob shell 1 through the rear opening 22. Referring back to FIG. 3, after the lock retainer 1 is placed within the knob shell 2, the rear end of the knob shell 2 is bent inward using a mechanical working process so that the rear opening 22 is constricted to a size smaller than that of the ring 13 and the lock retainer 1 is positioned within the knob shell 2. The neck part 15 projects out of the rear opening 22.

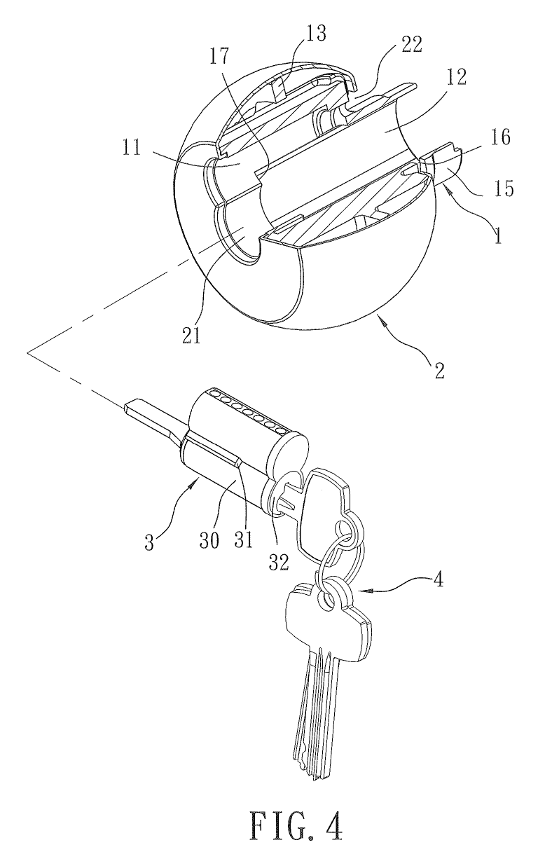

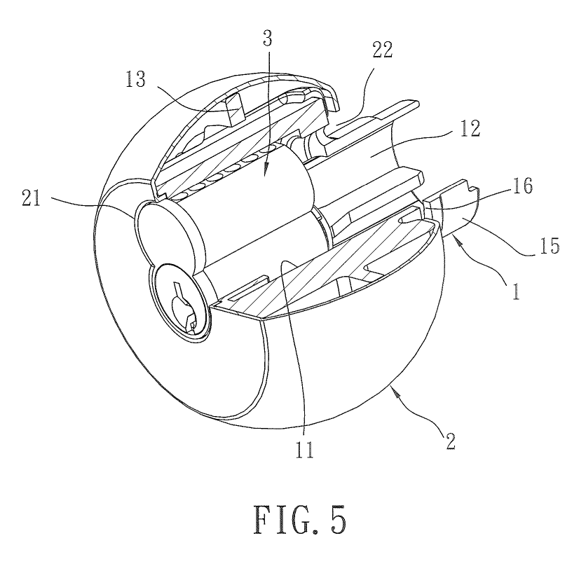

Referring once again to FIGS. 4 and 5, a key set 4 includes an unlocking key for unlocking the cylinder lock 3 and a wing-operating key for operating the wing 31 of the cylinder lock 3. The cylinder lock 3 is inserted into the lock-receiving hole 11 from the key hole 21 when the wing 31 is placed in a retracted position by inserting the wing-operating key into the cylinder lock 3 and turning the core 32. After the cylinder lock 3 is placed within the lock-receiving hole 11, the core 32 is turned in a reverse direction to project the wing 32 from the outer case 31 behind the shoulder face 17, so that the wing 32 engages the shoulder face 17 and so that the cylinder lock 3 is prevented from being released from the lock-receiving hole 11. To remove the cylinder lock 3 from the lock-receiving hole 11, the wing 31 must be placed in its retracted position so as to disengage the wing 31 from the shoulder face 17 using the wing-operating key.

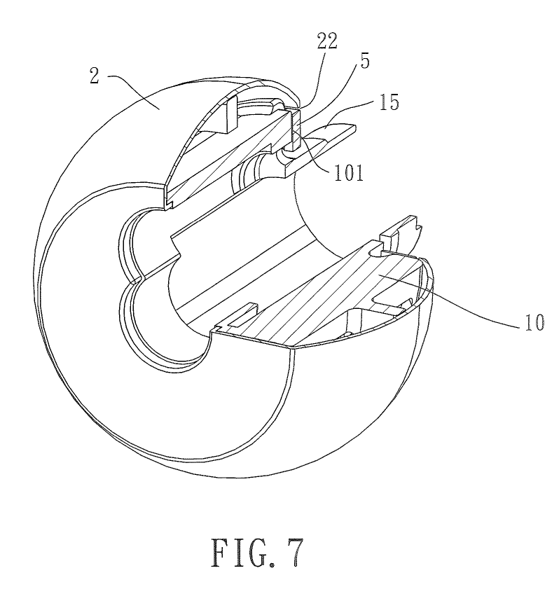

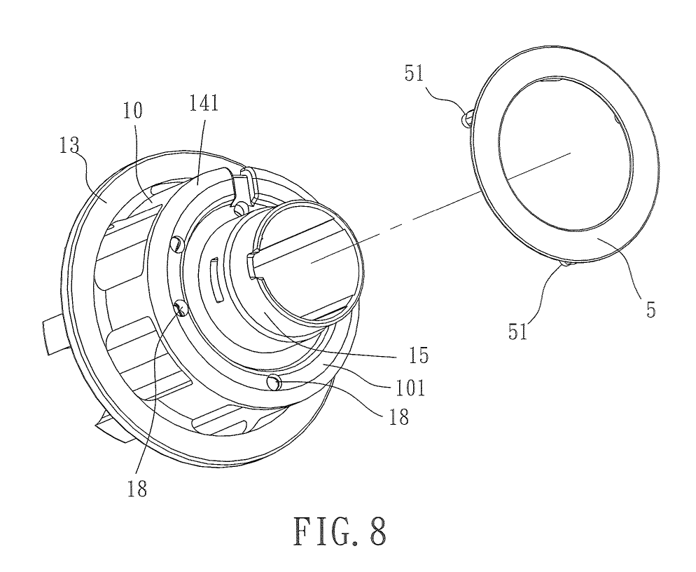

Referring once again to FIG. 3, the rear end of the knob shell 2 is bent inward to provide a bent part 23 having a substantial bending angle and width so that a large part of the rear end of the drum portion 10 is covered by the bent part 23. Referring to FIGS. 7 and 8, to facilitate the bending of the rear end of the knob shell 2, the rear end of the knob shell 2 may be bent in such a manner that the bending curvature or angle thereof and the width of the bent part thereof are reduced. An annular plate 5 is placed within the rear opening 22 of the knob shell 2 and is provided with angularly spaced apart engaging studs 51. The drum portion 10 further has an annular rear end face 101 extending substantially radially from a juncture between the drum portion 10 and the hollow neck part 15. The annular rear end face 101 has a plurality of slots 18. The engaging studs 51 of the annular plate 5 are engaged in the respective slots 18. Therefore, the annular plate 5 is attached to the annular rear end face 101 of the drum portion 10 and covers a gap formed between the hollow neck part 15 and the rear end of the knob shell 2.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A handle knob assembly comprising:
a knob shell having a front end provided with a key hole, and a rear end having a rear opening; and
a lock retainer disposed within said knob shell and including a hollow drum portion, a hollow neck part extending rearwardly from said drum portion and projecting out of said rear opening, a lock-receiving hole formed in said drum portion and aligned with said key hole, a plurality of annularly spaced apart ribs that project substantially radially from an outer periphery of said drum portion and that extend substantially in an axial direction, and a ring extending around said ribs and having a distal peripheral end extending substantially radially toward an inner surface of said knob shell.

2. The handle knob assembly as claimed in claim 1, wherein said distal peripheral end substantially abuts against said inner surface of said knob shell between said front and rear ends of said knob shell.

3. The handle knob assembly as claimed in claim 1, wherein each of said ribs has front and rear ends substantially extending to front and rear ends of said drum portion, respectively, and abuts against said inner surface of said knob shell at said front and rear ends of said knob shell.

4. The handle knob assembly as claimed in claim 3, wherein said lock retainer further includes a rear rim extending around a rear end of said drum portion, interconnecting said rear ends of said ribs, and abutting against said inner surface of said knob shell at said rear end of said knob shell.

5. The handle knob assembly as claimed in claim 1, wherein said key hole has a substantially 8-shaped cross section, said hollow neck part has a substantially circular through hole, and said lock-receiving hole has a front hole section of substantially 8-shaped cross section substantially corresponding to said key hole, a rear hole section communicated with said front hole section and said circular through hole, and a shoulder face formed between said front and rear hole sections, said rear hole section having a portion aligned with and corresponding in cross section to said circular through hole, said portion of said rear hole section being wider than said front hole section.

6. The handle knob assembly as claimed in claim 5, further comprising a cylinder lock disposed within said front and rear hole sections, said cylinder lock having an outer case, a core, and a retractable wing movable to project outward from said outer case, said wing being engageable with said shoulder face.

7. The handle knob assembly as claimed in claim 6, wherein said lock retainer further has a substantially C-shaped groove formed in said shoulder face.

8. A handle knob assembly comprising:
a knob shell having a front end provided with a key hole, and a rear end having a rear opening; and
a lock retainer disposed within said knob shell and including a hollow drum portion, a hollow neck part extending rearwardly from said drum portion and projecting out of said rear opening, a lock-receiving hole formed in said drum portion and aligned with said key hole, and a plurality of annularly spaced apart ribs that project substantially radially from an outer periphery of said drum portion and that extend substantially in an axial direction.

9. The handle knob assembly of claim 8, wherein said drum portion has an annular rear end face extending substantially radially from a juncture between said drum portion and said hollow neck part, and an annular plate attached to said annular rear end face.

10. The handle knob assembly of claim 9, wherein said annular plate covers a gap formed between said hollow neck part and said rear end of said knob shell.

11. A handle knob assembly comprising:
a knob shell having a front end provided with a key hole, and a rear end having a rear opening; and
a lock retainer disposed within said knob shell and including a hollow drum portion, a hollow neck part extending rearwardly from said drum portion and projecting out of said rear opening, a lock-receiving hole formed in said drum portion and aligned with said key hole, and a ring extending around said drum portion and having a distal peripheral end extending substantially radially toward an inner surface of said knob shell.

12. The handle knob assembly of claim 11, wherein said distal peripheral end of said ring abuts against said inner surface of said knob shell.

13. The handle knob assembly of claim 11, wherein said drum portion has an annular rear end face extending substantially radially from a juncture between said drum portion and said hollow neck part, and an annular plate attached to said annular rear end face.

14. The handle knob assembly of claim 13, wherein said annular plate covers a gap formed between said hollow neck part and said rear end of said knob shell.
